(19) United States
(12) Patent Application Publication
(10) Pub. No.: US 2006/0148573 A1
(43) Pub. Date: Jul. 6, 2006

(54) Method and system for cataloging advertising spots of an advertising enabled game

(76) Inventors: Daniel Willis, Stittsville (CA); Dhananjay Godse, Kanata (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,967

(22) Filed: Dec. 19, 2005

Related U.S. Application Data
(60) Provisional application No. 60/636,542, filed on Dec. 17, 2004.

(51) Int. Cl. A63F 13/00

(52) U.S. Cl. 463/43; 463/42

(57) ABSTRACT

A method for cataloging and populating advertising spots of an advertising enabled game includes using a catalog to select an advertising-spot of the advertising enabled game. For instance, the catalog is a catalog of itemized advertising spots for the advertising enabled game. An image is displayed including the selected advertising spot, in the context of the advertising enabled game. Advertising content is inserted into the image at the selected advertising spot, so as to produce a preview image that is representative of the advertising content when being displayed at the selected advertising spot during actual game play.

### REFERENCE TO PRIOR APPLICATION

This application claims benefit from U.S. Provisional application 60/636,542 filed on Dec. 17, 2004, the entire contents of which is incorporated herein by reference.

### FIELD OF THE INVENTION

The instant invention relates generally to advertising in games on the Internet, and more particularly to a WYSIWYG (what you see is what you get) method and system for cataloging advertising spots of advertising enabled games.

### BACKGROUND OF THE INVENTION

During recent years, computer gaming has gained increasing popularity, and today thousands of players are playing games all around the world. Predictably, interactive computer gaming played on Internet enabled platforms has blurred the line between games and other entertainment or communication media, and the avenues that are being explored in the development of gaming might well break new ground for interactive Internet applications in all areas of business relations and social life.

Due to their dynamic nature and specific appeal to certain audiences, computer games and especially games played on Internet enabled platforms provide the ideal vehicle for Internet advertising. Not only is it possible for an advertiser to target directly a specific group of customers, but optionally advertisements are incorporated directly into the computer game, enabling something akin to the well-known concept of product placement. It would be advantageous to have at hand a method and system for effectively combining the two concepts elucidated above, and thus building a bridge from the advertising world to the world of computer gaming.

However, an advertising enabled game suffers from a complexity that is not seen in most other advertising venues. Often, one or more ads are scattered across a virtual game world, and presentation of the ads depends on game play progression. Furthermore, some spots for displaying ads are adjacent to buildings or objects or other spots, all of which contribute to a given spot being more or less appealing than other spots. Additionally, games optionally support multi-media spots. In view of the complexity of this type of advertising, it would be advantageous for an advertiser to be able to see the relevant parameters and contextual screen shots for each spot, with links to any related spots, and filter and sort spots by a variety of criteria.

One method for simplifying the cataloging of in-game advertising spots is to standardize all spots such that they are interchangeable. Thus, a catalogue becomes a simple issue of statistics about a given video game and about the specific spot. Unfortunately, this is not desirable for use with video games due to their immersive environment. The advertising content that is displayed within a video game spot affects a quality of the game and, as such, is controlled by publishers and game developers. Further, advertising spot placement within a video game is of concern to advertisers. In the end, customization of an advertising spot—advertising content groupings is important and complex. Often, a plurality of geographically diverse entities—advertisers, brokers, advertising service providers, game providers, publishers, etc.—is involved in determining and approving the placement of advertising content into an advertising spot.

It would be advantageous to automate the publishing and use of game spot catalogs so as to more quickly expose available spots, and streamline approval processes.

### SUMMARY OF THE INVENTION

It is an object of at least one embodiment of the instant invention to link advertising sites with gaming sites to allow for specific and dynamic combinations of targeted advertisements with a proper advertising environment.

In accordance with an aspect of the instant invention, there is provided a method for cataloging and populating advertising spots of an advertising enabled game, comprising: selecting an advertising spot of an advertising enabled game from a catalog of itemized advertising spots for the advertising enabled game; displaying an image including the selected advertising spot in the context of the advertising enabled game; and, inserting advertising content into the image at the selected advertising spot, so as to produce a preview that is representative of the advertising content when being displayed at the selected advertising spot during actual game play.

In accordance with another aspect of the instant invention, there is provided a method for cataloging and populating advertising spots of an advertising enabled game, comprising: providing an advertising enabled game comprising a plurality of advertising spots, different advertising spots of the plurality of advertising spots having different characteristics; providing first data for itemizing each different advertising spot of the plurality of advertising spots and providing second data relating to at least a characteristic of each different advertising spot; retrievably storing the first data; retrievably storing the second data; and, linking the retrievably stored first data and the retrievably stored second data, for each different advertising spot of the plurality of advertising spots.

In accordance with another aspect of the instant invention, there is provided a method for cataloging and populating advertising spots of an advertising enabled game, comprising: providing a first database populated with data relating to characteristics for a set of itemized advertising spots of an advertising enabled game; providing a second database populated with data relating to a plurality of pieces of advertising content; providing an interface for accessing simultaneously data from the first database and data from the second database; and, using the interface, selecting data from the first database and data from the second database, the data from the first database relating to a known one of the itemized advertising spots having characteristics that are appropriate for rendering an impression of a piece of advertising content defined by the data from the second database

In accordance with another aspect of the instant invention, there is provided a method for cataloging and populating advertising spots of an advertising enabled game, comprising: providing a database populated with data relating to spot characteristics for each advertising spot of a set of itemized advertising spots of an advertising enabled game; providing a piece of advertising content for being displayed at an advertising spot of the set of itemized advertising spots, the piece of advertising content having ad characteristics associated therewith; and, using an interface, selecting data for retrieval from the database based on matching the ad characteristics to spot characteristics of a known one of the itemized advertising spots.

In accordance with another aspect of the instant invention there is provided a method for allowing a game provider to catalog a set of spots within an advertising enabled game.

In accordance with another aspect of the instant invention there is provided a method for allowing a game provider to register with an advertising broker, a catalog of a set of spots within an advertising enabled game.

In accordance with another aspect of the instant invention there is provided a method for allowing an advertisement service provider to interact with an advertising broker to view a catalog of at least a game.

In accordance with another aspect of the instant invention there is provided a method for allowing an advertisement service provider to work with a lease-specific catalog to select media that is appropriate to a spot, and submit the selected media for placement approval.

According to an optional aspect of the instant invention, unused spots are marked for wholesaling.

According to another optional aspect of the instant invention, multiple slots per spot are scheduled.

In accordance with another aspect of the instant invention there is provided a method for allowing a game provider to interact with an advertising broker to view content submitted for approval, and approve, reject, or request modifications to the content for a given lease.

### BRIEF DESCRIPTION OF THE DRAWINGS

Embodiments of the instant invention will now be described in conjunction with the following drawings, in which:

FIG. 1 is a high-level block diagram of a broker mediated advertisable gaming system;

FIG. 2 is a simplified flow diagram of a method according to an embodiment of the instant invention;

FIG. 3 is a simplified flow diagram of another method according to an embodiment of the instant invention;

FIG. 4 is a simplified flow diagram of another method according to an embodiment of the instant invention; and,

FIG. 5 is a simplified flow diagram of another method according to an embodiment of the instant invention.

### DETAILED DESCRIPTION OF THE INVENTION

Improving on cataloging techniques is beneficial for the purposes of maintaining video game quality while at the same time supporting the additional revenue stream potential of in-game advertising. Additionally, improved cataloging techniques offer potential advantages of improved workflow and automation. As such, a new and improved cataloging technique is described herein.

When an advertisement service provider (ADSP) has access to information relating to a video game's catalog of spots, still there is the problem of keeping up with the dynamic number of available advertising spots. For example, a game provider has the ability to enable any disabled spots within the game thereby changing the number of available spots, and an ADSP optionally enables multiple slots for a single spot, such that the catalogue is changing dynamically. The situation is particularly complex in a wholesaling environment, in which a lease-holding ADSP re-sells unused spots to other ADSPs, etc. Such dynamic changes are exceedingly difficult to track in a manual process, such as through a use of media kits. Furthermore, when the advertiser does not care about specific video game titles and is merely seeking a demographic, then the advertisement service provider addresses a catalog to aggregate catalogs of many individual games into a sufficient demographic. Now, the number of available spots is also changing dynamically across many different game titles.

Also, advertising content often is subjected to an approval process so as to ensure that a game provider is comfortable with the look, feel, and messaging associated with the advertising content that is proposed for being displayed within their game. This approval process requires that an advertisement service provider be able to communicate directly, indirectly or otherwise with the game provider until approval is granted.

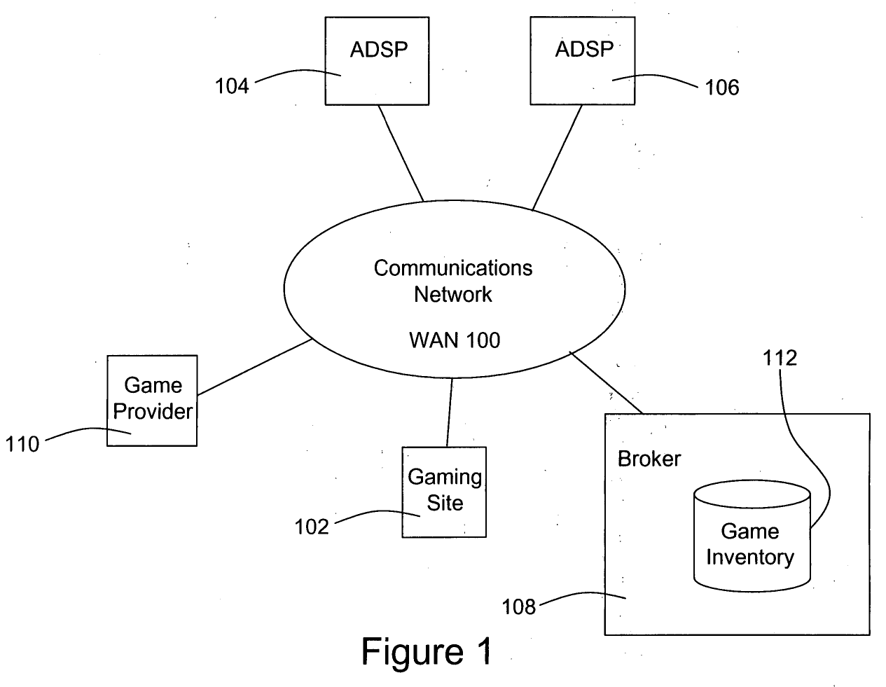

Referring now to FIG. 1, shown is a high-level block diagram of a broker mediated advertisable gaming system. A computer system of gaming site 102 is connected to Internet Protocol Wide Area Network (WAN) 100. Advertising service provider (ADSP) 104 and ADSP 106 also are connected to WAN 100. ADSP 104 and ADSP 106 implement one or more ad campaigns at a time. In the case of plural ad campaigns, ADSP 104 and ADSP 106 each schedule delivery of advertising content that is provided by different advertisers, to a limited number of available spots within instances of a game at gaming site 102. Clearly, it is a complex task managing and scheduling advertising content that is selected from a plurality of different advertising campaigns, which are being implemented by a plurality of ADSPs, for display at spots appearing within instances of a game at gaming site 102. Advertising broker site 108, which also is connected to WAN 100, acts as an intermediary between the plurality of ADSPs and gaming site 102, as described for instance in U.S. Provisional Patent Application 60/636,543, filed on Dec. 17, 2004 and in a co-pending United States patent application claiming priority therefrom and filed on Dec. 19, 2005, the entire contents of both of which are incorporated herein by reference.

A game provider 110 also is connected to WAN 100. The game provider 110 creates an advertising enabled game. For instance, when in execution on a computer system of gaming site 102, information relevant to advertising is provided via WAN 100 from one or both of ADSP 104 and ADSP 106. Based on the provided information, advertising content is displayed at spots within game instances of the advertising enabled game. The game provider 110 designs spots that differ in terms of suitability for displaying different types of advertising content. For instance a billboard-type spot within a game is suitable for displaying advertising content relating to a wide variety of products and services, whereas product placement-type ads are, by their nature, limited to those types of products appearing at various places throughout the game.

Typically, the game provider 110 registers advertising spots prior to release of the game. For instance, according to an embodiment the game provider 110 uses an interface, such as for instance a graphical user interface, to itemize each spot in the game. The game provider 110 then characterizes the itemized spots, for instance according to media type and/or size that is supported by the spot, and/or a value of the spot. The value of the spot is determined, for instance, by its visibility within the game, by the length of time the spot appears during game play, and/or by the frequency of appearance during game play. In the case of a game that is already in distribution, optionally the value of the spot is updated using statistical data relating to impressions served, billing information, demographic information etc., based on reported actual game play statistics. Optionally the reported actual game play statistics are displayed directly, for instance within a separate frame or within a window of the graphical user interface.

The game provider 110, using the graphical user interface, captures a suitable screen shot that is relevant to each of the itemized spots. Optionally, the game provider 110 places each itemized spot on a map, which is used to navigate quickly to a desired spot. This supports displaying two-dimensional representations of the itemized spot, to which proposed advertising content optionally is added so as to provide a preview of the advertising content within the context of the game. Further optionally, the game provider 110, using the graphical user interface, captures suitable three-dimensional views that are relevant to each of the itemized spots, where desirable. This is accomplished, for instance, by capturing a “video” of the game with an itemized ad spot in it and defining the itemized ad spot in each image within the video, or by capturing a video with an itemized ad spot shown as a “blue” screen for being automatically extracted, or by converting the game content—video segment—into a format for automatically having ad content inserted therein at the itemized ad spot.

The game provider 110 optionally lists conditions or special information relating to the itemized spots. Additionally, the game provider 110 optionally reviews and filters the existing spots, to determine whether financial and game play goals have been met.

According to one implementation, the graphical user interface is exposed as a stand-alone application. In this case, the graphical user interface interacts with the game provider's native game-building application, when one is present, in such a way that one of the graphical user interface and the native game-building application is a “plug-in” or “module” for the other. The graphical user interface application also interacts with a database of ADSP 104 and/or ADSP 106, so as to facilitate creative content extraction and mapping.

The graphical user interface allows a game provider 110 to create a spot by specifying its size and position, for instance with drawing tools on top of a rendered screen, and then automatically generate default properties based on the specified size and location. The game provider 110 then is able to override the defaults or assign additional properties. If the graphical user interface is not tightly integrated with the game-building application, when one is present, then the graphical user interface is able to read the configuration file generated by game developers that are associated with the game provider 110, as it is of value that the catalog be an accurate accounting of the game's spots. Spots optionally are deleted, and/or their properties are modified using the graphical user interface.

Using the graphical user interface to perform the above-mentioned operations results in spot-specific and game-specific information. Advantageously, the spot-specific information optionally is accessible from the game-specific information, for instance as hyperlinks in an image map. All spots that are part of a single plane or cluster optionally are highlighted. Selection of spots optionally is by clicking on an image or map, searching, iterating, etc. The spot-specific and game-specific information is optionally persisted within the game provider's intranet initially, but eventually must be persisted as a catalog by the advertising broker site 108. The catalog for the advertising enabled game in the preceding discussion is independent of any lease.

When an advertisement service provider, such as for instance ADSP 104, wishes to reserve the advertising enabled game, the ADSP 104 acquires read-only access to the catalog in either a thick- or thin-client application. ADSP 104 optionally specifies a date range, in which case advertising broker site 108 queries a game inventory 112 to determine if any spots are available, either as part of an unreserved or wholesaled game. Additionally, any reach information for the spots optionally is displayed. Of course, any spots that have not been enabled are not revealed to ADSP 104 in the catalog. Alternatively, enabled and disabled spots are revealed providing advertisers an opportunity to entice game providers to open up more advertising spots. Furthermore, any spots that have been enabled, but are reserved by another ADSP such as for instance ADSP 106, are revealed to ADSP 104 but are clearly marked as unavailable. If spots that are marked as unavailable subsequently become available, then this change in status is reflected to the ADSP 104 the next time ADSP 104 acquires read-only access to the catalog. Similarly, if additional spots become unavailable, then the change also is reflected to the ADSP 104 the next time ADSP 104 acquires read-only access to the catalog.

If ADSP 104 subsequently leases the advertising enabled game, or reserves any wholesaled spots, then relevant information in the game inventory database 112, as well as spotted field information 114, is exposed to ADSP 104, such as the content associated with a spot, and its status, such as for instance not submitted, pending, needs modification, approved, declined, etc.

ADSP 104, now having unfilled advertising spots for advertising content, interacts with one or more advertisers. The graphical user interface is used to select content for available spots, and to preview the advertising content in context by appropriate texture mapping and transformation of the data overlaid on any provided screen shot. Optionally, images are edited to ensure that the color palettes match, etc. Finally, previews optionally are exported or sent for review by advertisers or other individuals or agencies associated with ADSP 104. Advantageously, the graphical user interface supports an overall ad management system that is WYSIWYG (what you see is what you get), and that is on-line and interactive. If the ADSP 104 and/or the advertiser are unhappy with the appearance of a selected content in a particular ad-spot, then this is immediately obvious at the selection stage since the graphical user interface is WYSIWYG. Dealing with such an issue at the selection stage avoids the costs associated with actually putting the ad into circulation, and then gauging its effectiveness based on gamer feedback, etc. In other words, the ADSP 104 and/or advertiser optionally preview a plurality of advertising content pieces at a same ad spot. The advertising content that has the best “fit” or “feel” at that particular ad spot then is selected, and other ad spots are investigated for the remaining advertising content. Optionally, multiple slots are assigned to a particular ad spot, such that a plurality of different advertising content is displayed over time using the same particular ad spot. Slots need not necessarily have identical duration, and the slot frequency may vary. Slot definition information relating to an itemized ad spot optionally is displayed within a separate frame or within a window of the graphical user interface.

Such an iterative approach to placing advertising content in a game helps to ensure that each specific piece of advertising content is displayed in a manner that is most effective for the advertiser. It also ensures that the final game product, including provided advertising content, retains the look and feel intended by the game provider 110. The process is highly interactive and is optionally performed on-line. In this way, optionally ADSP 104 signs on to a graphical user interface session from an office in Los Angeles, U.S.A. and an advertiser signs on to the same graphical user interface from an office in Paris, France. Changes made from the office in Los Angeles are reflected at the office in Paris, as though the Paris staff is looking over the shoulder of the Los Angeles staff. At any time, one or the other of the Los Angeles staff and the Paris staff have the option of signing off, allowing the other party to continue working. Similarly, if an outside opinion is required, then others may sign into the current session so as to be able to make changes and provide additional input.

Ultimately, content that is satisfactory to ADSP 104 is submitted to an approving authority, such as for instance game provider 110, for approval thereby. Optionally, other entities are involved in the game provider approval process, or have a separate approval process of their own. Optionally, the approving authority includes any one or more of a game provider, designated third parties, a game-console provider, an advertiser, a game publisher, an ad agency, an advertisement broker, and an ADSP. If ADSP 104 stores content, then submission of the content for approval comprises providing a reference to a publicly visible data server or alternatively to a secure server. For instance, ADSP 104 sends an e-mail message containing a link allowing the approving party to see, for approval purposes, a screenshot including the proposed advertising content placed into the ad spot. If advertising broker site 108 stores content, then submission of the content for approval comprises uploading the content to advertising broker site 108, whereupon the content is stored in a visible database. For instance, advertising broker site 108 sends an e-mail message containing a link allowing the approving party to see, for approval purposes, a screenshot including the proposed advertising content placed into the ad spot. Either way, the user interface used by both ADSP 104 and game provider 110 accesses the content in the same manner. If game provider 110 stores content, then advertising broker site 108 transfers the content from initial storage by ADSP 104 to game provider 110, and the graphical user interface retrieves the content from local storage. Submitted but not approved content optionally is stored by one of ADSP 104, advertising broker site 108, or game provider 110.

When content is submitted, game provider 110 is made aware of the fact the next time the catalog is opened. Alternatively, the game provider 110 is automatically pro-actively notified by advertising broker site 108. As described supra the game provider 110 uses the graphical user interface to preview the submitted content in a manner similar to that carried out by ADSP 104 and/or the advertiser. Individual spots are approved, rejected, or marked for modification. A report of any changes associated with the approval process is relayed back to ADSP 104 for subsequent action. Optionally, ADSP 104 and game provider 110 enter into an interface session and discuss changes in an on-line and interactive fashion. Optionally, approval is granted at the end of the session, or the modified content is submitted for consideration by a more formal approval process.

When game provider 110 approves content using the graphical user interface, advertising broker site 108 is notified. Advertising broker site 108 then secures the approved content, retrieves and applies any keys or certificates required to authenticate the secured content, and transfers the secured content to ADSP 104 for storage in a media database associated therewith, which is accessed by gaming site 102 during a game session.

Optionally, reports are generated within the graphical user interface to indicate to ADSP 104 the overall status of the lease. For instance, a report is generated indicating four spots submitted and approved, two spots submitted and awaiting modification, and one spot not yet submitted.

Further optionally, other reporting information pertaining to the catalog is provided via the graphical user interface. Such information optionally is searchable, for instance by an advertiser, or by an advertising service provider. In the case of an advertiser, reports are generated relating to groupings of advertising content of the advertiser, grouping of spots displaying the advertiser's content, all available advertising spots, etc. This reporting functionality supports advertising campaign review to determine if specific impression and reach criteria are being met, and supports making changes to an advertising campaign already in progress. Additionally, reporting the status of advertising spots supports a bidding system for any spots that are not currently filled with dedicated advertising content. For instance, an advertiser or an ADSP etc. view a report to determine advertising spots that are currently displaying default data, and therefore generating little or no revenue. The advertiser or ADSP then bids an amount they are willing to pay to have their advertising content displayed in place of the default data. Such bidding is optionally an open process either competitive or otherwise, or is offered during a predetermined period of time, the spots in question being awarded to a highest bidder at the end of the predetermined period of time. In another example, an advertiser or ADSP bids on spots that are currently displaying standby advertising content. In general, standby advertising content is displayed when regular advertising content is not available for display at a particular advertising spot, as described in greater detail in U.S. Provisional Patent Application 60/636,543, filed on Dec. 17, 2004 and in a co-pending United States patent application claiming priority therefrom and filed on Dec. 19, 2005. Often, the standby content is displayed at a discount compared to rates for displaying regular advertising content. Accordingly, the advertiser or ADSP optionally bids an amount greater than the standby rate to have their own advertising content displayed at a particular advertising spot in place of the standby content.

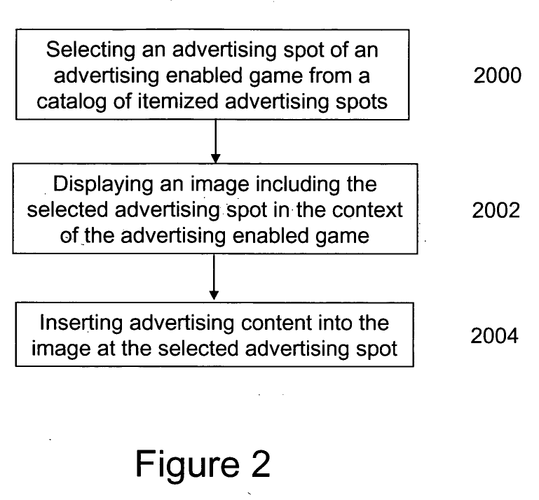

Referring now to FIG. 2, shown is a simplified flow diagram of a method according to an embodiment of the instant invention. At step 2000 an advertising spot of an advertising enabled game is selected from a catalog of itemized advertising spots for the advertising enabled game. At step 2002 an image including the selected advertising spot in the context of the advertising enabled game is displayed. At step 2004 advertising content is inserted into the image at the selected advertising spot, so as to produce a preview image that is representative of the advertising content when being displayed at the selected advertising spot during actual game play. Accordingly, the image is displayed in a manner that is referred to as “what you see is what you get,” or WYSIWYG.

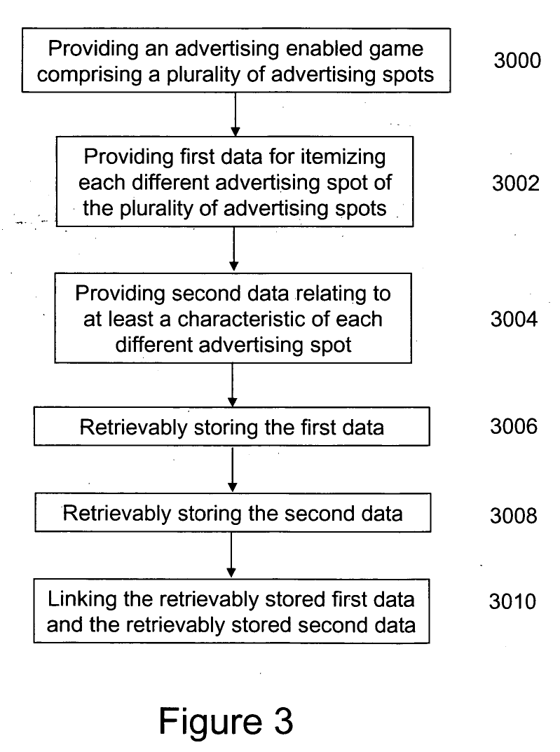

Referring now to FIG. 3, shown is a simplified flow diagram of another method according to an embodiment of the instant invention. At step 3000 an advertising enabled game is provided, the advertising enabled game comprising a plurality of advertising spots. In particular, different advertising spots of the plurality of advertising spots have different characteristics. At step 3002, first data is provided for itemizing each different advertising spot of the plurality of advertising spots. At step 3004, second data is provided relating to at least a characteristic of each different advertising spot. At step 3006 the first data is retrievably stored and at step 3008 the second data is retrievably stored. At step 3010 the retrievably stored first data and the retrievably stored second data are linked, for each different advertising spot of the plurality of advertising spots.

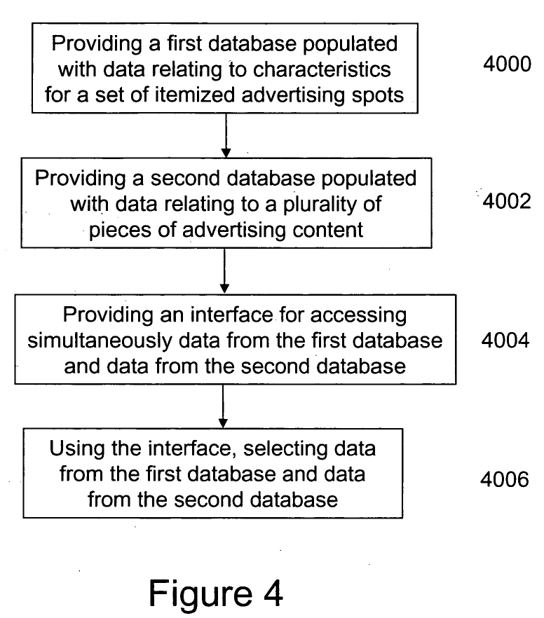

Referring now to FIG. 4, shown is a simplified flow diagram of another method according to an embodiment of the instant invention. At step 4000 a first database is provided, the first database populated with data relating to characteristics for a set of itemized advertising spots of an advertising enabled game. At step 4002 a second database is provided, the second database populated with data relating to a plurality of pieces of advertising content. At step 4004 an interface is provided for accessing simultaneously data from the first database and data from the second database. At step 4006 using the interface, selecting data from the first database and data from the second database, the data from the first database relating to a known one of the itemized advertising spots having characteristics that are appropriate for rendering an impression of a piece of advertising content defined by the data from the second database.

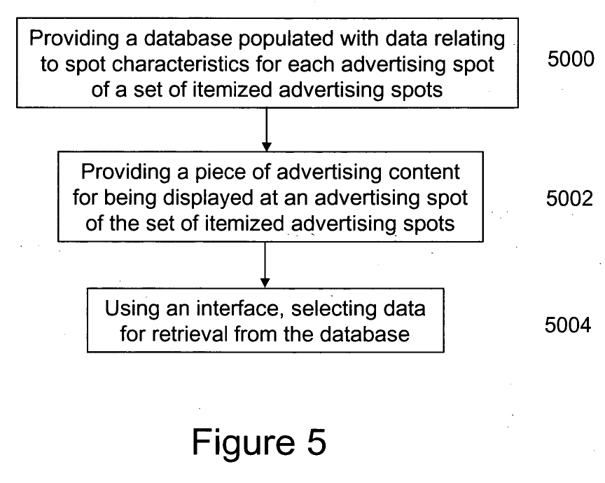

Referring now to FIG. 5, shown is a simplified flow diagram of another method according to an embodiment of the instant invention. At step 5000 a database is provided, the database populated with data relating to spot characteristics for each advertising spot of a set of itemized advertising spots of an advertising enabled game. At step 5002 a piece of advertising content is provided for being displayed at an advertising spot of the set of itemized advertising spots, the piece of advertising content having ad characteristics associated therewith. At step 5004 an interface is used for selecting data for retrieval from the database, based on matching the ad characteristics to spot characteristics of a known one of the itemized advertising spots.

Of course, the reference numerals referred to in the discussion of the methods according to FIGS. 2-5 are not intended to imply any particular order. In many cases method steps are optimally performed in an order that differs from an order that is presented in the specific, and non-limiting, examples of FIGS. 2-5. Furthermore, the term advertising content is intended to include various advertising formats, including but not limited to texture data, music, multimedia data, video data, and text data.

Numerous other embodiments may be envisaged without departing from the spirit and scope of the instant invention. All specific examples have been provided for illustrative purposes only and are not intended to be limiting in any way.

What is claimed is:

1. A method for cataloging and populating advertising spots of an advertising enabled game, comprising:
selecting an advertising spot of an advertising enabled game from a catalog of itemized advertising spots for the advertising enabled game;
displaying an image including the selected advertising spot in the context of the advertising enabled game; and,
inserting advertising content into the image at the selected advertising spot, so as to produce a preview image that is representative of the advertising content when being displayed at the selected advertising spot during actual game play.

2. A method according to claim 1, comprising displaying other data with the displayed image.

3. A method according to claim 2, wherein the other data is searchable.

4. A method according to claim 2, wherein the other data is provided by a game provider.

5. A method according to claim 2, wherein the other data is based on statistical data obtained during actual game play.

6. A method according to claim 2, wherein the other data relates to game type information.

7. A method according to claim 2, wherein the other data relates to information that is specific to the selected advertising spot.

8. A method according to claim 7, wherein the other data is based on statistical data obtained during actual game play.

9. A method according to claim 7, wherein the other data relates to demographic information for the selected advertising spot.

10. A method according to claim 7, wherein the other data relates to billing information for the selected advertising spot.

11. A method according to claim 7, wherein the other data relates to impressions served during actual game play and using the selected advertising spot.

12. A method according to claim 7, wherein the other data relates to a current status of the selected advertising spot.

13. A method according to claim 12, wherein the status is indicative of an availability of the selected advertising spot.

14. A method according to claim 12, wherein the status is indicative of a type of advertising content currently available for display by the selected advertising spot.

15. A method according to claim 14, wherein the type of advertising content is selected from a group consisting of regular advertising content, standby advertising content and default content.

16. A method according to claim 1, wherein displaying an image comprises providing data to a first destination via a communications network, the data for displaying an image local to the first destination.

17. A method according to claim 16, wherein displaying an image comprises displaying an animation including the selected advertising spot in the context of the advertising enabled game.

18. A method according to claim 16, comprising providing data to a second destination via the communications network, the data for displaying a same image local to the second destination.

19. A method according to claim 18, comprising displaying an image local to the first destination during a first period of time and displaying an image local to the second destination during a second period of time overlapping with the first period of time.

20. A method according to claim 19, wherein changes effected to the image at either one of the first destination and the second destination is reflected by same changes in the image being displayed at the other one of the first destination and the second destination.

21. A method according to claim 20, wherein the first destination and the second destination are geographically distinct locations.

22. A method according to claim 1, wherein the selected advertising spot is a portion of the image, the selected advertising spot being distinguishable from the remainder of the image based on an indicator within the selected advertising spot.

23. A method according to claim 22, wherein the visible indicator is of a predetermined color.

24. A method according to claim 1, wherein a game provider defines the selected advertising spot in the image.

25. A method according to claim 1, wherein the image is formatted for having advertising content inserted automatically at the selected advertising spot.

26. A method according to claim 1, comprising retrievably storing the preview image.

27. A method according to claim 26, comprising submitting the preview image for approval by an approving authority.

28. A method according to claim 27, wherein the approving authority is selected from the group consisting of: a game provider, a game-console provider, an advertiser, a game publisher, an ad agency, an advertisement broker, an advertisement service provider, a third party designated by the game provider, and a third party designated by the console provider.

29. A method according to claim 1, comprising submitting the preview image for approval by an approving authority.

30. A method according to claim 29, wherein the approving authority is selected from the group consisting of: a game provider, a game-console provider, an advertiser, a game publisher, an ad agency, an advertisement broker, an advertisement service provider, a third party designated by the game provider, and a third party designated by the console provider.

31. A method according to claim 1, comprising submitting the preview image for approval by a plurality of approving authorities.

32. A method according to claim 31, wherein the plurality of approving authorities is selected from the group consisting of: a game provider, a game-console provider, an advertiser, a game publisher, an ad agency, an advertisement broker, an advertisement service provider, a third party designated by the game provider, and a third party designated by the console provider.

33. A method for cataloging and populating advertising spots of an advertising enabled game, comprising:
providing an advertising enabled game comprising a plurality of advertising spots, different advertising spots of the plurality of advertising spots having different characteristics;
providing first data for itemizing each different advertising spot of the plurality of advertising spots and providing second data relating to at least a characteristic of each different advertising spot;
retrievably storing the first data;
retrievably storing the second data; and,
linking the retrievably stored first data and the retrievably stored second data, for each different advertising spot of the plurality of advertising spots.

34. A method according to claim 33, wherein providing first data comprises extracting the first data from the advertising enabled game.

35. A method according to claim 34, wherein providing second data comprises extracting the second data from the advertising enabled game.

36. A method according to claim 33, wherein the retrievably stored first data and the retrievably stored second data comprise entries of a database, the entries relating to the advertising enabled game.

37. A method according to claim 36, comprising providing an interface for interacting with the database and for displaying the second data in human intelligible form.

38. A method according to claim 37, wherein the interface is a graphical user interface.

39. A method according to claim 38, comprising using the graphical interface for displaying status data, the status data indicative of an availability of each different advertising spot of the plurality of advertising spots.

40. A method according to claim 37, comprising, using the interface, retrieving the second data from the database for matching advertising content to one of the plurality of advertising spots.

41. A method according to claim 40, wherein the second data is indicative of an availability of the one of the plurality of advertising spots.

42. A method according to claim 41, comprising displaying the second data in human intelligible form via the interface.

43. A method according to claim 40, comprising displaying the second data in human intelligible form via the interface.

44. A method according to claim 43, wherein the at least a characteristic relates to a captured screen shot that is relevant to a particular itemized advertising spot of the plurality of advertising spots, and comprising displaying an impression of a piece of advertising content at the particular itemized advertising spot within the captured screen shot so as to generate a preview.

45. A method according to claim 44, comprising submitting the generated preview for approval by an approving entity.

46. A method according to claim 27, wherein the approving authority is selected from the group consisting of: a game provider, a game-console provider, an advertiser, a game publisher, an ad agency, an advertisement broker, an advertisement service provider a third party designated by the game provider, and a third party designated by the console provider.

47. A method according to claim 44, comprising submitting the generated preview for approval by a plurality of approving authorities.

48. A method according to claim 47, wherein the plurality of approving authorities is selected from the group consisting of: a game provider, a game-console provider, an advertiser, a game publisher, an ad agency, an advertisement broker, an advertisement service provider, a third party designated by the game provider, and a third party designated by the console provider.

49. A method according to claim 33, wherein the at least a characteristic relates to a type of media that is supported by a particular itemized advertising spot of the plurality of advertising spots.

50. A method according to claim 33, wherein the at least a characteristic relates to a size of media that is supported by a particular itemized advertising spot of the plurality of advertising spots.

51. A method according to claim 33, wherein the at least a characteristic relates to an assigned advertising value of a particular itemized advertising spot of the plurality of advertising spots.

52. A method according to claim 33, wherein the at least a characteristic relates to a limitation imposed upon a particular itemized advertising spot of the plurality of advertising spots, the limitation imposed by a provider of the advertising enabled game.

53. A method according to claim 33, wherein the at least a characteristic relates to additional information concerning a particular itemized advertising spot of the plurality of advertising spots, the additional information provided by a provider of the advertising enabled game.

54. A method according to claim 33, wherein the at least a characteristic relates to a captured screen shot that is relevant to a particular itemized advertising spot of the plurality of advertising spots.

55. A method according to claim 33, wherein the at least a characteristic relates to a location of a particular itemized advertising spot of the plurality of advertising spots within the advertising enabled game.

56. A method according to claim 33, comprising placing each itemized spot on a map, for supporting navigation to a desired one of the itemized advertising spots of the plurality of advertising spots.

57. A method for cataloging and populating advertising spots of an advertising enabled game, comprising:
providing a first database populated with data relating to characteristics for a set of itemized advertising spots of an advertising enabled game;
providing a second database populated with data relating to a plurality of pieces of advertising content;
providing an interface for accessing simultaneously data from the first database and data from the second database; and,
using the interface, selecting data from the first database and data from the second database, the data from the first database relating to a known one of the itemized advertising spots having characteristics that are appropriate for rendering an impression of a piece of advertising content defined by the data from the second database.

58. A method according to claim 57, wherein the interface is a graphical user interface.

59. A method according to claim 57, wherein the selected data from the first database comprises a screen shot including the known one of the itemized advertising spots.

60. A method according to claim 59, comprising overlaying the selected data from the first database with the selected data from the second database, for obtaining a preview of an impression of a piece of advertising content, which is defined by the data from the second database, in the context of the advertising enabled game.

61. A method according to claim 60, comprising retrievably storing the obtained preview.

62. A method according to claim 60, comprising submitting the obtained preview for approval by a provider of the advertising enabled game.

63. A method according to claim 60, comprising displaying other data with the obtained preview.

64. A method according to claim 63, wherein the other data is provided by a game provider.

65. A method according to claim 63, wherein the other data is based on statistical data obtained during actual game play.

66. A method according to claim 63, wherein the other data relates to game type information.

67. A method according to claim 63, wherein the other data relates to information that is specific to the known one of the itemized advertising spots.

68. A method according to claim 67, wherein the other data is based on statistical data obtained during actual game play.

69. A method according to claim 67, wherein the other data relates to demographic information for the known one of the itemized advertising spots.

70. A method according to claim 63, wherein the other data relates to billing information for the known one of the itemized advertising spots.

71. A method according to claim 63, wherein the other data relates to impressions served during actual game play and using the known one of the itemized advertising spots.

72. A method according to claim 63, wherein the other data relates to a current status of the known one of the itemized advertising spots.

73. A method according to claim 72, wherein the current status is indicative of an availability of the known one of the itemized advertising spots.

74. A method according to claim 72, wherein the current status is indicative of a type of advertising content currently available for display by the known one of the itemized advertising spots.

75. A method according to claim 74, wherein the type of advertising content is selected from a group consisting of regular advertising content, standby advertising content and default content.

76. A method according to claim 60, comprising editing the obtained preview.

77. A method according to claim 76, comprising retrievably storing the edited preview.

78. A method according to claim 76, comprising submitting the edited preview for approval by a provider of the advertising enabled game.

79. A method for cataloging and populating advertising spots of an advertising enabled game, comprising:
providing a database populated with data relating to spot characteristics for each advertising spot of a set of itemized advertising spots of an advertising enabled game;
providing a piece of advertising content for being displayed at an advertising spot of the set of itemized advertising spots, the piece of advertising content having ad characteristics associated therewith; and,
using an interface, selecting data for retrieval from the database based on matching the ad characteristics to spot characteristics of a known one of the itemized advertising spots.

80. A method according to claim 79, wherein the interface is a graphical user interface.

81. A method according to claim 79, comprising retrieving the selected data from the database for being displayed by the interface.

82. A method according to claim 81, wherein the data retrieved from the database comprises a screen shot including the known one of the itemized advertising spots.

83. A method according to claim 82, comprising overlaying the data retrieved from the database with the piece of advertising content, for obtaining a preview of an impression of the piece of advertising content in the context of the advertising enabled game.

84. A method according to claim 83, comprising retrievably storing the obtained preview.

85. A method according to claim 83, comprising submitting the obtained preview for approval by one of a provider of the advertising enabled game and a third party designated by the provider of the advertising enabled game.

86. A method according to claim 83, comprising editing the obtained preview.

87. A method according to claim 86, comprising retrievably storing the edited preview.

88. A method according to claim 86, comprising submitting the edited preview for approval by one of a console provider, and a third party designated by the console provider.

89. A method according to claim 83, comprising submitting the obtained preview for approval by an approving authority.

90. A method according to claim 89, wherein the approving authority is selected from the group consisting of: a game provider, a game-console provider, an advertiser, a game publisher, an ad agency, an advertisement broker, an advertisement service provider, a third party designated by the game provider, and a third party designated by the console provider.

91. A method according to claim 83, comprising submitting the obtained preview for approval by a plurality of approving authorities.

92. A method according to claim 91, wherein the plurality of approving authorities is selected from the group consisting of: a game provider, a game-console provider, an advertiser, a game publisher, an ad agency, an advertisement broker, an advertisement service provider, a third party designated by the game provider, and a third party designated by the console provider.
